(19) United States
(12) Patent Application Publication
(10) Pub. No.: US 2026/0327503 A1
(43) Pub. Date: Oct. 22, 2026

(54) DEMULSIFYING BLOCK COPOLYMER, METHOD FOR FORMING SUCH COPOLYMER, AND METHOD OF DEMULSIFYING AN EMULSION OF PETROLEUM AND WATER

(71) Applicant: Dow Global Technologies LLC, Midland, MI (US)

(72) Inventors: Michael L. Tulchinsky, Midland, MI (US); Tzu-Chi Kuo, Midland, MI (US); Thomas H. Kalantar, Midland, MI (US); Kathryn Grzesiak, Midland, MI (US); Roxanne M. Jenkins, Missouri City, TX (US); Pramod Akhade, Houston, TX (US)

(21) Appl. No.: 19/129,779

(22) PCT Filed: Dec. 12, 2023
(86) PCT No.: PCT/US2023/083534

§ 371 Date: May 14, 2025

(51) Int. Cl. C10G 33/04; C08G 65/26

(52) U.S. Cl. CPC C10G 33/04; C08G 65/2627

(57) ABSTRACT

The present disclosure is concerned with a demulsifying block copolymer that is the reaction product of an aniline derived starter in the presence of an alkoxylation catalyst with a first alkylene oxide selected from butylene oxide or propylene oxide to form an intermediate polymer, where the intermediate polymer is reacted with ethylene oxide in the presence of the alkoxylation catalyst to form the demulsifying block copolymer.

### FIELD OF DISCLOSURE

Embodiments of the present disclosure are directed towards emulsions and specifically in reducing water in petroleum emulsions.

### BACKGROUND

In the extraction, transportation, and refining of petroleum in its various forms, such as diluted bitumen (“dilbit”), emulsions of petroleum and water are commonly formed, but are undesirable. Once formed, the emulsions can be stabilized by a variety of naturally occurring surface-active compounds found in petroleum such as surfactants and fine mineral particles.

An important step in addressing emulsions of petroleum and water is to break the interfacial film formed at the oil/water interface to enable the coalescence and separation of water from the petroleum. Separation of the petroleum from water and solids (e.g., from the dilbit) may be performed more efficiently by using additives to break the emulsion. Known additives mostly belong to different classes of organic polymers, for example, ethylene oxide and propylene oxide copolymers, alkoxylated phenol formaldehyde resins, alkoxylated (poly)amines, or alkoxylated epoxy resins. Current chemical treatments can reduce the water and solid contents in the petroleum to some degree, but there are still desires to remove more water and residuals to mitigate fouling and corrosion of process units. As such, there is a need to develop an efficient additive to further improve the reduction of water and minerals from such emulsions, including those formed from dilbit products.

### SUMMARY

The present disclosure provides for an efficient additive to improve the reduction of water and minerals from emulsions of petroleum and water, including those formed from dilbit products. Regarding the present disclosure, there is provided a demulsifying block copolymer that is the reaction product of an aniline derived starter containing an alkoxylation catalyst with a first alkylene oxide of butylene oxide to form an intermediate polymer, where the intermediate polymer is reacted with ethylene oxide in the presence of the alkoxylation catalyst to form an embodiment of the demulsifying block copolymer of the present disclosure.

Embodiments of the present disclosure further include a method of demulsifying an emulsion of petroleum and water that includes adding a demulsifying block copolymer to the emulsion of petroleum and water, where the demulsifying block copolymer comprises the reaction product of an aniline derived starter containing an alkoxylation catalyst with a first alkylene oxide selected from butylene oxide or propylene oxide to form an intermediate polymer; and the intermediate polymer with ethylene oxide in the presence of the alkoxylation catalyst to form the demulsifying block copolymer. The method further includes allowing the emulsion having the demulsifying block copolymer to then separate into a petroleum phase and a water phase. For the various embodiments, adding the demulsifying block copolymer to the emulsion can include adding 2 to 900 parts per million of the demulsifying block copolymer to the emulsion.

For the various embodiments, the aniline derived starter can have a structure of Formula I:

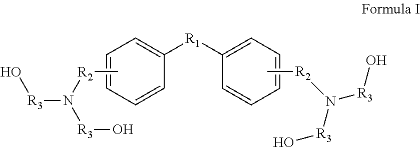

where R₁ is a C1 to C3 alkylene or alkylidene; each R₂ is a C0 to C3 alkylene or alkylidene; and R₃ is a C2 or C3 alkylene. For the various embodiments, the aniline derived starter can be 0.3 to 2.2 weight percent of the total weight of the demulsifying block copolymer. For the various embodiments, the aniline derived starter can be 4,4′-methylenebis(N,N-di(2-hydroxypropyl)aniline).

For the various embodiments of the demulsifying block copolymer, the first alkylene oxide used to form the intermediate polymer is butylene oxide. For these various embodiments, the weight ratio of the butylene oxide to the ethylene oxide in the demulsifying block copolymer can be from 1.2 to 2.7. In addition, for these embodiments the weight average molecular weight of the demulsifying block copolymer can be in a range of 10,000 to 18,000 g/mol.

In alternative embodiments of the demulsifying block copolymer, the first alkylene oxide used to form the intermediate polymer can be propylene oxide. For these various embodiments, the weight ratio of the propylene oxide to the ethylene oxide in the demulsifying block copolymer is from 1.0 to 6.0. In addition, for these embodiments the weight average molecular weight of the demulsifying block copolymer can be in a range of 7,000 to 15,000 g/mol.

### DETAILED DESCRIPTION

The present disclosure provides for an efficient additive to improve the reduction of water and minerals from emulsions of petroleum and water, including those formed from dilbit products. Embodiments of the present disclosure provide for the synthesis and use of a demulsifying block copolymer that enable significant water reduction in emulsions of petroleum and water. The demulsifying block copolymer of the present disclosure employs an initiator containing aromatic moieties and primary amino groups to form an aniline derived starter, which in turn undergoes an alkoxylation reaction with either propylene oxide (PO) or butylene oxide (BO) to form an intermediate polymer, where the intermediate polymer undergoes alkoxylation with ethylene oxide (EO), as described herein, to form the demulsifying block copolymer of the present disclosure.

As used herein, the term “petroleum” includes unprocessed crude oil, crude oil emulsion, unprocessed bitumen, emulsion of refined crude oil, dilbit and dilbit products. As used herein, the terms emulsion or emulsions of petroleum and water can include a petroleum-in-water emulsion and/or a water-in-petroleum emulsion. As used herein, the term “water” can include, for example, a brine, a connate water, fresh water, surface water, well water, distilled water, carbonated water, engineered water, sea water and a combination thereof. For brevity, the word “water” will be used herein (unless clearly indicated otherwise), where it is understood that one or more of “brine,” “connate water,” “fresh water”, “surface water,” “well water”, “distilled water,” “carbonated water,” “engineered water” and/or “sea water” can be used interchangeably. As used herein, “ethylene oxide” or “EO” is also known as oxirane and has the formula C₂H₄O. As used herein, “propylene oxide” or “PO” includes 1,2-propylene oxide and 1,3-propylene oxide. Preferably, the propylene oxide or PO is 1,2-propylene oxide. As used herein, “butylene oxide” or “BO” includes ethyloxirane and 2,3-dimethyloxirane. Preferably, the butylene oxide or BO is ethyloxirane.

For the various embodiment, the demulsifying block copolymer of the present disclosure is the reaction product of an aniline derived starter containing an alkoxylation catalyst with a first alkylene oxide selected from butylene oxide or propylene oxide to form an intermediate polymer, where the intermediate polymer is reacted with ethylene oxide in the presence of the alkoxylation catalyst to form the demulsifying block copolymer of the present disclosure. In a more specific embodiment, the demulsifying block copolymer of the present disclosure is the reaction product of an aniline derived starter containing the alkoxylation catalyst with the first alkylene oxide of butylene oxide to form the intermediate polymer, where the intermediate polymer is reacted with ethylene oxide in the presence of the alkoxylation catalyst to form the demulsifying block copolymer of the present disclosure. In an additional embodiment, the demulsifying block copolymer of the present disclosure is the reaction product of an aniline derived starter containing the alkoxylation catalyst with the first alkylene oxide of propylene oxide to form the intermediate polymer, where the intermediate polymer is reacted with ethylene oxide in the presence of the alkoxylation catalyst to form the demulsifying block copolymer of the present disclosure.

For the various embodiments, the aniline derived starter of the present disclosure can have a structure of Formula I:

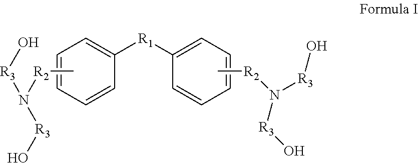

where R₁ is a C1 to C3 alkylene or alkylidene; each R₂ is a C0 to C3 alkylene or alkylidene; and R₃ is a C2 or C3 alkylene. Preferably, each R₂ is identical to the other R₂ moiety in Formula I, and each R₃ is identical to the other R₃ moieties in Formula I (e.g., the compound of Formula I is symmetrical). It is, however, possible that different R₂ and/or R₃ moieties are present in the aniline derived starter of Formula I (e.g., the compound of Formula I is asymmetrical). For the various embodiments, it is also possible that oligomers of Formula I (e.g., two or more of the structure of Formula I linked together) can be used in the embodiments provided herein.

For the various embodiments, it is preferred that the aniline derive derived starter is 4,4′-methylenebis(N,N-di(2-hydroxypropyl)aniline of Formula II:

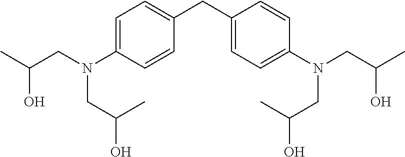

where R₁ is a C1 alkylene namely methylene; each R₂ is not present (i.e., a C0 alkyl) and R₃ is a C3 alkylene namely 1,2-propylene. Other preferred formulae for the aniline derived starter of the present disclosure include those where R₁ is an ethylidene; each R₂ is not present and R₃ is a C4 alkylene namely 1,2-butylene.

For the various embodiments, the aniline derived starter of Formula I is formed from an initiator containing aromatic moieties and primary amino groups. For example, the initiator can have the structure of Formula III:

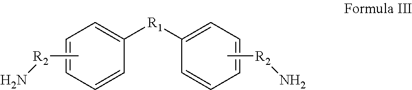

where R₁ is a C1 to C3 alkylene or alkylidene and each R₂ is a C0 to C3 alkylene or alkylidene. Preferably, each R₂ is identical to the other R₂ moiety in Formula I. It is, however, possible that different R₂ moieties are present in the initiator of Formula III. Preferably, the initiator of Formula III is 4,4′-methylenedianiline (MDA), where R₁ is methylene and each R₂ is not present (i.e., a C0 alkyl) and the primary amine moieties are in the para position relative to the position of the R₁ group. Other preferred initiators of Formula III include, but are not limited to, 4,4′-ethylidenedianiline, 3,3′-ethylidenedianiline and 4,4′-propylidenedianiline.

For the various embodiments, the initiator of Formula III undergoes an alkoxylation reaction with either propylene oxide (PO) or butylene oxide (BO) to form the aniline derived starter of Formula I. For the various embodiments, the alkoxylation reaction to form the aniline derived starter is an autocatalytic reaction, as are known in the art. In forming the aniline derived starter, the reaction mixture of the initiator of Formula III and either of PO or BO has a molar ratio of 1:3 to 1:5 (initiator to PO or BO). Preferably, the reaction mixture has a molar ratio of 1:4 (initiator to PO or BO). For the various embodiments, the alkoxylation reaction can take place at a reaction temperature of 80° C. to about 180° C. Preferably, the alkoxylation reaction can take place at a reaction temperature of 100° C. to about 160° C. Reaction times for the alkoxylation reaction can be from 12 hours to 2 days. Those skilled in the art will be able to determine appropriate conditions with, at most, routine experimentation.

For the various embodiments, the aniline derived starter is then reacted under alkoxylation conditions in the presence of the alkoxylation catalyst and the first alkylene oxide selected from BO or PO to form an intermediate polymer. The alkoxylation catalyst used for the alkoxylation reaction can be, for example, potassium hydroxide (KOH) or a double metal cyanide compound, as are known in the art. Prior to the alkoxylation reaction, aqueous KOH catalyst may be introduced and the water removed azeotropically to have the starter dry. Various techniques may be used, including for instance the use of benzene and/or toluene followed by application of azeotropic distillation at ambient or reduced pressure, elevated temperature or both, employing nitrogen purge, or a combination of these.

The BO or PO are reacted with the aniline derived starter under alkoxylation conditions in the presence of a catalyst. In a non-limiting embodiment illustrative of suitable alkoxylation conditions, this reaction may be carried out at an elevated temperature or temperatures ranging from about 80° C. to about 180° C. In other non-limiting embodiments, the temperature may range from about 100° C. to about 160° C. Reaction times for the alkoxylation reaction can be from 2 hours to 4 days. Those skilled in the art will be able to determine appropriate conditions with, at most, routine experimentation.

Preferably, the alkoxylation reaction is conducted in the presence of an effective amount of potassium hydroxide as catalyst. The amount of the catalyst may, in some embodiments, range from about 0.1 wt. % to about 20 wt. % by weight, based on the total weight of the starter. In some embodiments, the amount may range from about 1 wt. % to 10 wt. %.

In a typical illustrative process, the starter containing the alkoxylation catalyst can be mixed with either BO or PO and the reaction continued until alkoxylation is completed to form the intermediate polymer. The reaction may be subjected to digestion periods (e.g., about 1-10 hours at about 100° C. to 160° C.). between butylene oxide, propylene oxide and ethylene oxide additions and/or after the butylene oxide, propylene oxide, and/or ethylene oxide addition.

Following the alkoxylation reaction, the intermediate polymer may be discharged from the reactor without removal of the catalyst. If desired, the intermediate polymer may be treated to neutralize the catalyst

For the various embodiments, the intermediate polymer is then reacted with ethylene oxide (EO) in the presence of the alkoxylation catalyst, as described herein, to form an embodiment of the demulsifying block copolymer (Formula IV) of the present disclosure.

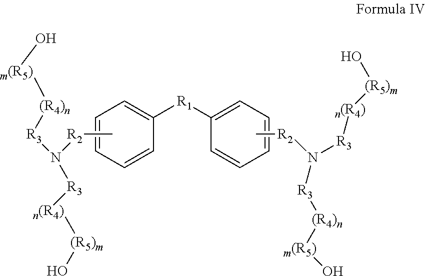

where R₁, R₂ and R₃ are as previously discussed, where R₄ is C3 or C4 alkyleneoxy group, R₅ is C2 ethyleneoxy group, n is 5 to 50 and m is 4 to 70. For the various embodiments of the demulsifying block copolymer, the first alkylene oxide used to form the intermediate polymer is BO (i.e., R₄ is C4). For these various embodiments, the weight ratio of the BO to the EO in the demulsifying block copolymer can be from 1.2 to 2.7. In addition, for these embodiments the weight average molecular weight of the demulsifying block copolymer can be in a range of 10,000 to 18,000 g/mol. For the present embodiments (i.e., R₄ is C4), n is 5 to 20 and m is 10 to 70. In other various embodiments of the demulsifying block copolymer, the first alkylene oxide used to form the intermediate polymer is PO (i.e., R₄ is C3). For these various embodiments, the weight ratio of the PO to the EO in the demulsifying block copolymer can be from 1.0 to 6.0. In addition, for these embodiments the weight average molecular weight of the demulsifying block copolymer can be in a range of 7,000 to 15,000 g/mol. For the present embodiments (i.e., R₄ is C3), n is 10 to 50 and m is 4 to 40. For the various embodiments provided herein, the initiator of Formula III can be 0.3 to 2.2 weight percent of the total weight of the demulsifying block copolymer.

Embodiments of the present disclosure also include a method of forming the demulsifying block copolymer of the present disclosure. As discussed herein, the aniline derived starter is reacted in the presence of the alkoxylation catalyst with the first alkylene oxide selected from butylene oxide or propylene oxide under alkoxylation conditions to form the intermediate polymer. Next, the intermediate polymer is reacted with ethylene oxide in the presence of the alkoxylation catalyst under alkoxylation conditions, as discussed herein, to form the demulsifying block copolymer of the present disclosure.

Examples of forming the demulsifying block copolymers of the present disclosure are outlined as follows. In the first example, an initial step involves the autocatalytic propoxylation of 4,4′-methylenedianiline (MDA) with PO to form an embodiment of Formula I, as discussed herein and as seen below, where R₁ is a C1 alkylene (methylene); each R₂ is C0 (i.e., not present) and R₃ is a C3 alkylene (1,2-propylene). The embodiment of Formula I, as seen below, is then alkoxylated with PO (or BO) in the presence of catalytic amounts of KOH after azeotropically distilling water off with toluene, as discussed herein. The obtained PO-polymer (or BO-polymer) is then ethoxylated with EO, as discussed herein, to make an embodiment of the demulsifying block copolymer of the present disclosure. This sequence of steps is depicted for the demulsifying block copolymer having the PO-EO copolymer moiety as follows:

### Synthesis of MDA/PO/EO Demulsifying Block Copolymer

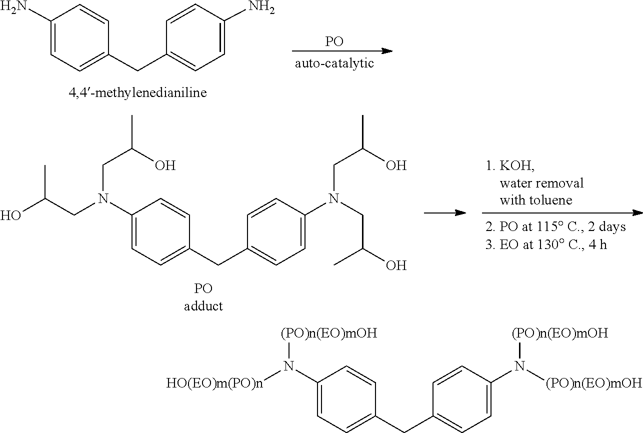

For the synthesis of MDA/PO/EO demulsifying block copolymer, the MDA can be present in 1.0 to 2.5 wt. % based on the total weight of the demulsifying block copolymer, while the PO to EO weight ratios can be in the approximate range from 2 to 5. The gel permeation chromatography (GPC) based weight average molecular weights, M_{w}, can be in the range of 6,000 to 12,000 g/mol, with relative solubility numbers (RSN, described in the Examples section below) in the range of 10 to 15. The demulsifying block copolymer meeting the above requirements can effectively remove water from diluted bitumen and conventional crude oil water emulsions, with significantly better performance than the benchmark at the same dose rate.

The sequence of steps for the demulsifying block copolymer having the BO-EO copolymer moiety can be as follows:

### Synthesis of MDA/PO/BO/EO Demulsifying Block Copolymer

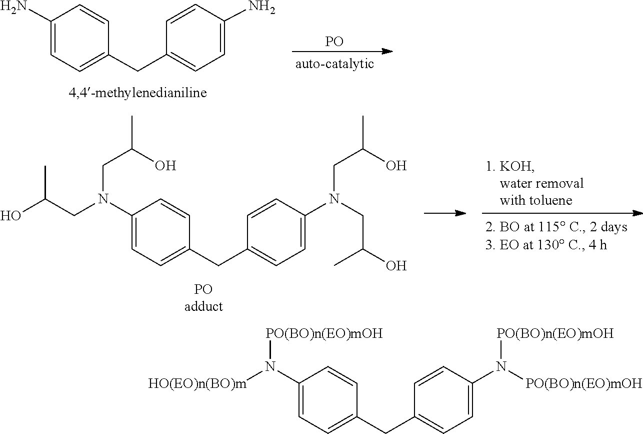

For the synthesis of MDA/PO/BO/EO demulsifying block copolymer, the MDA can be present in 0.3 to 1.5 wt. % based on the total weight of the demulsifying block copolymer, while the BO to EO weight ratios can be in the approximate range from 2 to 1. The gel permeation chromatography (GPC) based weight average molecular weights, M_{w}, can be in the range of 8,000 to 20,000 g/mol, with RSN in the range of 10 to 15. The demulsifying block copolymer meeting the above requirements can effectively remove water from diluted bitumen and conventional crude oil water emulsions, with significantly better performance than the benchmark at the same dose rate.

Embodiments of the present disclosure also include a method of demulsifying an emulsion of petroleum and water that includes adding the demulsifying block copolymer of the present disclosure to the emulsion and allowing the emulsion to separate into a petroleum phase and a water phase. Using the demulsifying block copolymer of the present disclosure in demulsifying an emulsion of petroleum and water into a water phase and a petroleum phase may be carried out in a conventional manner. For example, demulsifying the emulsion of petroleum and water into the petroleum phase and the water phase and then separating and recovering the petroleum phase and water phase may be carried out by treating the emulsion with a demulsifying amount of the demulsifying block copolymer of the present disclosure. Examples of demulsifying the emulsion of petroleum and water into the water phase and the petroleum phase can include adding 2 to 900 parts per million of the demulsifying block copolymer to the emulsion. Other suitable amounts for demulsifying the emulsion of petroleum and water into the water phase and the petroleum phase can include adding 5 to 900 parts per million of the demulsifying block copolymer to the emulsion or adding 50 to 900 parts per million of the demulsifying block copolymer to the emulsion. Once formed, the water phase is separated from the petroleum phase. Once separated, either one of the water phase and/or the petroleum phase can be recovered for further processing.

For the various embodiments, the demulsifying block copolymer of the present disclosure can help to destabilize the emulsion of petroleum and water so as to enhance water droplet coalescence. A mixing process can be used with the emulsion of petroleum and water in breaking the emulsion with the demulsifying block copolymer of the present disclosure. For example, sufficient agitation can be used to allow the demulsifying block copolymer of the present disclosure to mix thoroughly with the emulsion of petroleum and water, followed by a period of flow inside a separator to promote gravity separation. The process can also include a sufficient retention time in the separator(s) to allow the water droplets to settle. The process may also require the addition of heat, electric grids, and coalescers to facilitate or completely resolve the emulsion.

As appreciated, the efficacy of the demulsifying block copolymer of the present disclosure can be dependent upon a number of factors such as the properties of the petroleum and/or the water of the emulsion, the mixer type, and the design and operating conditions of the demulsifying equipment. The most effective conditions for the demulsification may be at least partially determined through the use of a bottle testing procedure, as is known.

Other factors that can influence the demulsification can include, but are not limited to, temperature, pH, type of crude oil, brine composition, and droplet size and distribution. An increase in temperature can result in a decrease in emulsion stability. The pH of the emulsion of petroleum and water may also affect the performance of the demulsifying block copolymer of the present disclosure.

The following examples are presented to describe preferred embodiments and utilities of the invention and are not meant to limit the invention unless otherwise stated in the claims appended hereto.

### EXAMPLES

The examples below are provided to be illustrative only and are not intended to define or limit the embodiments in any way. In the Inventive Examples (EX) and Comparative Examples (CE), various terms and designations for materials are used including, for instance, the following:

TABLE 1
Materials

| Chemical Name | Supplier |
|---|---|
| 1,2-Propylene Oxide (PO) | Sigma-Aldrich |
| Ethylene Oxide (EO) | ARC specialty products, Balchem |
| | Corporation |
| 1,2-Butylene Oxide (BO) | Sigma-Aldrich |
| 4,4′-Methylenedianiline (MDA) | Sigma-Aldrich |
| Dilbit | As described herein |
| d-chloroform | Cambridge Isotope Laboratories, Inc. |

### Tests and Devices

Molecular compositions, including weight percent (wt. %) of 4,4′-methylenedianiline (MDA), BO, PO, and EO in the samples were determined by integration of ¹H NMR spectra (Varian 400-NMR spectrometer (400 MHz, ¹H) with an autosampler) of the materials in d-chloroform (CDCl₃).

Molecular weights were determined using gel permeation chromatography (GPC, Agilent 1260 Infinity system equipped with a refractive index detector and columns with a linear MW operating range up to 30,000 g/mol, using Agilent EasiVial PS-L polystyrene standards). GPC samples were prepared by weighing ~10 mg of each sample into pre-weighted vials, and the accurate weights were then recorded. Tetrahydrofuran (THF) was added to prepare 1.0 mg/mL solutions. Samples were shaken to dissolve solids and filtered into vials for GPC. Analysis was performed on an Agilent 1260 Infinity equipped with 1 PLgel 3 μm×50 mm×7.5 mm Guard column and 2 PLgel 3 μm×50 mm×7.5 m Mixed E columns maintained at 35° C. The samples were eluted with THE at a flowrate of 1.77 mL/min. and using the RID as the detector. Weight-average molecular weight (M_{w}), number-average molecular weight (Mₙ) and polydispersity index (PDI=M_{w}/Mₙ) were reported.

Relative solubility number (RSN) measurements for the EX and CE were conducted using the following literature procedure incorporated here by reference. The RSNs of the EX and CE were determined using toluene-ethylene glycol dimethyl ether (EGDE) in a volumetric ratio of 2.6:97.4 as the RSN solvent. In this method, 0.1 gram (g) of additive was dissolved in 3 milliliters (mL) of the RSN solvent and the resulting solution was then titrated with deionized (DI) water until a visible, persistent turbidity appeared. The volume of the DI water in milliliters used as titrant divided by the weight in grams of the additive was recorded as the RSN value. The details of the original method can be found in Wu, J.; Xu, Y.; Dabros, T.; Hamza, H. “Development of a method for measurement of relative solubility of nonionic surfactants,” Colloids Surf., A 2004, 232, 229-237, which is incorporated herein by reference.

### Examples (EX) 1-10

### Syntheses of Demulsifying Block Copolymer MDA/PO/EO

The reactions to form the demulsifying block copolymer MDA/PO/EO were carried out in a parallel pressure reactor (PPR®, Unchained Labs, formerly Symyx Technologies) setup containing 48 (6×8) reactors. Propylene oxide (PO) and ethylene oxide (EO) were delivered via a Teledyne ISCO syringe pump (Model 260D) equipped with a robotically controlled needle and compressed gas micro valve (Bio-Chem valve p/n 100T2-S493). The layout for each of the used cells was designed using Library Studio®. A glass insert along with a removable PEEK stir paddle for each cell were dried in a vacuum oven at 125° C.

### Step 1: Initial Auto-Catalytic Reaction with PO

4,4′-Methylenedianiline (MDA) (1.98 g; 0.01 mol) was charged manually to the glass inserts under nitrogen. Since each PPR reactor capacity does not exceed 6 mL, identical amounts of components were used in all 8 PPR reactors of each module to make a larger amount of the MDA/PO starter. The glass inserts along with the stir paddles were loaded to the corresponding PPR reactor wells and the PPR reactors were sealed, the cells were charged with 2.32 g (2.80 mL; 0.04 mol) amounts of PO. The temperature was increased to 140° C. and reaction mixtures were stirred for 24 hours after reaching the process temperature. The pressure profile showed that the reactions were completed, producing MDA(PO)₄ adduct. The cells were vented and purged with nitrogen to remove residual PO. After cooling and venting, samples of the MDA(PO)₄ adduct were taken for NMR analyses.

### Step 2: MDA(PO)₄ Reaction with PO

The MDA(PO)₄ adduct with approximately four PO per each MDA as described above served as a starter for the subsequent alkoxylations. The MDA(PO)₄ adduct (10 g) was mixed with calculated amounts of 50 wt. % KOH solutions to make 20 wt. % KOH mixture relative to the MDA(PO)₄ adduct. Then about 100-150 mL of toluene was added and water was removed azeotropically at 110° C. using a Dean-Stark trap. The remaining toluene was evaporated in vacuum. The dry MDA(PO)₄ adduct containing the KOH catalyst was weighed into glass inserts. The glass inserts along with the stir paddles were loaded to the corresponding PPR wells and the reactors were sealed. The cells were charged by robot with calculated amounts of PO. The temperature was increased to 115° C. and reaction mixtures were stirred for 2 days after reaching the process temperature. The pressure in the reactors gradually leveled off, indicating that the reactions were completed to produce MDA(PO)n intermediate. The cells were cooled, vented and purged with nitrogen to remove any residual PO.

### Step 3: MDA(PO)n Intermediate Reaction with EO

To the obtained MDA(PO)n intermediates, the calculated amounts of EO were introduced by robot at 50° C., then the temperature was increased to 130° C. and the reactors were stirred for 4 hours. The pressure curves were consistent with the reaction completion. After cooling and venting the system as described above, small samples of the resulting demulsifying block copolymer MDA/PO/EO of the present disclosure were taken from each reactor for NMR and GPC analyses.

The synthesis produced samples with different compositions and different ratios of PO/EO monomers. The data is listed in Table 2.

### Evaluation of the Demulsifying Block Copolymer MDA/PO/EO Block Copolymer for Diluted Bitumen (Dilbit) Dewatering

Laboratory scale dilbit was produced from oil sands obtained from various operators in Alberta, Canada. Approximately 1500 g of oil sands were used in a single batch and resulted in about 200-300 g extracted bitumen froth. First, the oil sand was placed in a heated vessel (58° C.). Approximately 3000 g of water containing 600 parts per million (ppm) KCl was added to the oil sand while continuously stirring the mixture. The stir speeds varied at different times during the process to introduce large amounts of shear. While continuing to stir, nitrogen was bubbled up through the mixture to increase the separation of bitumen so that it rose to the top of the mixture as bitumen froth. After 20 minutes (min), the process was stopped and the froth was scraped off the top of the vessel. The collected bitumen froth was diluted with naphtha to produce dilbit using a ratio of 0.4 g naphtha per 1.0 g bitumen froth.

The efficiency of the demulsifying block copolymer MDA/PO/EO was evaluated using a high throughput bottle test method using a liquid handler. Each run contained 12 samples including controls. Dilbit was homogenized using an impeller attached to an overhead mixer (900 rpm for 10 min). Next the dilbit was mixed using a dual-axis speedmixer (FlakTek 2,000 rpm for 1.5 min, twice). Then the dilbit was placed in a container on the deck of an 8-channel liquid handler, and the robot dispensed the dilbit into 12 vials (4 mL per vial). Stock solutions of the demulsifying block copolymer MDA/PO/EO were formulated in a solvent mixture of 3:1 xylene:isopropanol, by mass. The demulsifying block copolymer MDA/PO/EO concentration in the stock solutions was 0.6 wt. %. Subsequently, the robot added 200 μL of the additive stock solutions into the vials to test the additives at 300 ppm with respect to the dilbit. The samples were mixed at 3500 rpm for 1 minute using the dual-axis speed mixer, and then kept at 60° C. for 45 min. The samples were then mixed again on the dual-axis speed mixer at 3500 rpm for 30 seconds (s). After that, they were centrifuged at 2000 rpm (470 g relative centrifuging acceleration) for 5 min, and then about 150 mg from each vial at a fixed depth (about ⅓ of the same volume from the top) was withdrawn via syringe for Karl Fischer analysis. The water contents of the samples were measured using a Metrohm oven Karl Fischer Titrator with an autosampler, which heats the sample to 120° C. to remove all the water from the sample.

The results on remaining water in the samples are normalized with the control (containing no additive) and are presented in Table 2 as relative percent water. Lower relative water percentages correspond to the better performance of the additive.

### Comparative Examples (CE) A-D

### Comparative Examples A-C

CE A-C were prepared in a manner similar to EX 1-10 as discussed above, but the tested demulsifying compositions of the comparative examples had chemical properties that fell outside of those for the demulsifying block copolymer MDA/PO/EO, where the differences are noted in Table 2.

### CE D

CE D tested the performance of the commercially available benchmark additive, which is an amine-initiated polyol block copolymer with an approximate average molecular weight of 4,500 daltons sold under the tradename Demtrol™. The benchmark additive, which contained a different amine initiator and a lower average MW than the demulsifying block copolymer of the present disclosure showed lower performance at 300 ppm than the demulsifying block copolymer of the present disclosure as seen in Table 2.

TABLE 2
Compositions, relative solubility numbers, MWs, and
performance results at 300 ppm additive for the
demulsifying block copolymer MDA/PO/EO.

| | | | | | | | | | Rel- |
|---|---|---|---|---|---|---|---|---|---|
| | | Wt. | Wt. | Wt. | | | | | ative |
| | | % | % | % | PO/ | | | | % |
| | RSN | Amine | PO | EO | EO | Mn | Mw | PDI | H₂O^{a} |
| EX 1 | 14.6 | 1.38 | 59.48 | 39.14 | 1.52 | 10437 | 10779 | 1.03 | 3.1 |
| EX 2 | 14.8 | 1.66 | 59.97 | 38.37 | 1.56 | 8293 | 8516 | 1.03 | 3.1 |
| EX 3 | 15.2 | 2.07 | 60.33 | 37.60 | 1.60 | 6956 | 7086 | 1.02 | 3.1 |
| CE A | 9.6 | 2.07 | 85.21 | 12.72 | 6.67 | 8128 | 8422 | 1.04 | 83.7 |
| CE B | 15.6 | 2.32 | 58.38 | 39.29 | 1.48 | 6139 | 6223 | 1.01 | 15.5 |
| CE C | 8.9 | 0.90 | 74.47 | 24.63 | 3.02 | 21079 | 23896 | 1.13 | 57.4 |
| EX 4 | 11.9 | 1.28 | 67.83 | 30.89 | 2.19 | 11329 | 11881 | 1.05 | 3.1 |
| EX 5 | 12.3 | 1.71 | 67.42 | 30.87 | 2.18 | 8643 | 8871 | 1.03 | 3.1 |
| EX 6 | 12.3 | 2.08 | 67.93 | 29.98 | 2.27 | 7171 | 7305 | 1.02 | 3.1 |
| EX 7 | 10.2 | 1.48 | 72.71 | 25.81 | 2.82 | 10386 | 10882 | 1.05 | 4.7 |
| EX 8 | 10.4 | 1.81 | 73.62 | 24.57 | 3.0 | 8524 | 8750 | 1.03 | 4.7 |
| EX 9 | 11.1 | 2.16 | 73.20 | 24.64 | 2.97 | 7310 | 7483 | 1.02 | 4.7 |
| EX 10 | 10.6 | 1.34 | 78.13 | 20.52 | 3.81 | 11510 | 12096 | 1.05 | 3.1 |
| CE D | | | | | | | | | 6.7 |
| Control^{b} | | | | | | | | | 100.0 |

^{a}measured water % divided by the control's water % × 100%;
^{b}xylene/isopropanol (3:1).
PDI-polydispersity index (Mw/Mn).

### Examples (EX) 11-14

### Syntheses of Demulsifying Block Copolymer MDA/PO/BO/EO

The reactions were carried out as described above for EX 1-10, except for the following changes.

Step 1: identical to EX 1-10.

Step 2: MDA-(PO)₄ Adduct Reaction with BO.

The MDA-(PO)₄ adduct with approximately four PO per each MDA as described above served as a starter for the subsequent alkoxylations. The MDA-(PO)₄ adduct (10 g) was mixed with calculated amounts of 50 wt. % KOH solutions to make 20 wt. % KOH mixture relative to the MDA-(PO)₄ adduct. Then about 100-150 mL of toluene was added and water was removed azeotropically at 110° C. using a Dean-Stark trap. The remaining toluene was evaporated in vacuum. The dry MDA-(PO)₄ adduct containing the KOH catalyst was weighed into glass inserts. The glass inserts along with the stir paddles were loaded to the corresponding PPR wells and the reactors were sealed. The cells were charged by robot with calculated amounts of BO. The temperature was increased to 115° C. and reaction mixtures were stirred for 2 days after reaching the process temperature. The pressure in the reactors gradually leveled off, indicating that the reactions were completed to form MDA(PO)₄(BO)n. The cells were cooled, vented and purged with nitrogen to remove residual BO.

Step 3: MDA(PO)₄(BO)n reaction with EO

EO was introduced with the MDA(PO)₄(BO)n at 50° C., then the temperature was increased to 130° C. and the reactors were stirred for 4 hours. The pressure curves were consistent with the reaction completion to form the demulsifying block copolymer MDA/PO/BO/EO. After cooling and venting the system as described above, small samples of the demulsifying block copolymer MDA/PO/BO/EO were taken from each reactor for NMR and GPC analyses.

The synthesis produced demulsifying block copolymers MDA/PO/BO/EO with different compositions and different ratios of BO/EO monomers. The data is listed in Table 3.

### Evaluation of Demulsifying Block Copolymer MDA/PO/BO/EO for Dilbit Dewatering

The efficiency of the demulsifying block copolymer MDA/PO/BO/EO was tested as described above for the demulsifying block copolymer MDA/PO/EO. The results on remaining water in the samples are normalized with the control (containing no additive) and are presented in Table 3 as relative percent water. Lower relative water percentages correspond to the better performance of the additive.

### Comparative Examples (CE) E-G

CE E-F were prepared in a manner similar to EX 11-14 as discussed above, but the tested demulsifying compositions of the comparative examples had chemical properties that fell outside of those for the demulsifying block copolymer MDA/PO/BO/EO, where the differences are noted in Table 3.

CE G tested the performance of the commercially available benchmark additive, which is an amine-initiated polyol block copolymer with an approximate average molecular weight of 4,500 daltons sold under the tradename Demtrol™. The benchmark additive, which contained a different amine initiator and a lower average MW than the demulsifying block copolymer of the present disclosure showed lower performance at 300 ppm than the demulsifying block copolymer of the present disclosure as seen in Table 3.

TABLE 3
Compositions, relative solubility numbers, MWs, and performance results at 300 ppm
additive for the demulsifying block copolymer MDA/PO/BO/EO inventive samples.

| | | wt. % | wt. % | wt. % | wt. % | | | | Relative |
|---|---|---|---|---|---|---|---|---|---|
| Ex # | RSN | MDA | PO | EO | BO | Mn | Mw | PDI | % H₂O^{a} |
| EX 11 | 12.4 | 0.38 | 0.48 | 42.1 | 57.0 | 6926 | 8557 | 1.24 | 10.6 |
| EX 12 | 12.9 | 0.80 | 0.91 | 40.8 | 57.5 | 16090 | 17676 | 1.10 | 7.5 |
| EX 13 | 14.5 | 1.08 | 0.97 | 40.5 | 57.5 | 11566 | 14373 | 1.24 | 2.6 |
| EX 14 | 9.9 | 1.12 | 1.04 | 32.4 | 65.4 | 11408 | 14513 | 1.27 | 9.0 |
| CEE | 23.1 | 0.77 | 0.98 | 55.9 | 42.4 | 14174 | 16433 | 1.16 | 29.4 |
| CE F | 6.2 | 2.29 | 1.98 | 40.6 | 55.1 | 5858 | 6346 | 1.08 | 51.5 |
| CE G | | | | | | | | | 13.4 |
| Control^{b} | | | | | | | | | 100.0 |

^{a}Average of two measurements, divided by the control × 100%;
^{b}xylene/isopropanol (3:1).

### Examples (EX) 15-17

Examples 15 and 16 are large scale synthesis of the demulsifying block copolymer MDA-(PO)₄(BO)m(EO)n, while EX 17 is a large scale synthesis of the demulsifying block copolymer MDA-(PO)₄(EO)n.

The reactions were carried out in a Symyx PPR® setup containing a plate with 48 (6×8) reactors. 24 reactors contained identical components and conditions to make a large sample for Example 15 and the other 24 reactors were similarly employed to make a large sample for Example 16. Similarly, 24 reactors contained identical components and conditions to make a large sample for EX 17 were also prepared. Propylene oxide (PO), butylene oxide (BO) and ethylene oxide (EO) were delivered via an ISCO syringe pump equipped with a robotically controlled needle and compressed gas micro valve. The layout for each of the used cells was designed using Library Studio®. A glass insert along with a removable PEEK stir paddle for each cell were dried in a vacuum oven at 125° C.

### EX 15 and 16

Step 1: The initial auto-catalytic reaction with PO was carried out similar to the step 1 procedure in EX 1-10 to give the MDA(PO)₄ adduct.

Step 2: MDA(PO)₄ adduct reactions with BO. The MDA-(PO)₄ adduct with approximately four PO per each MDA as described above served as a starter for the subsequent alkoxylations. The MDA(PO)₄ adduct (10 g) was mixed with calculated amounts of 50 wt. % KOH solutions to make 20 wt. % KOH mixture relative to the MDA(PO)₄ adduct. Then about 100-150 mL of toluene was added and water was removed azeotropically at 110° C. using a Dean-Stark trap. The remaining toluene was evaporated in vacuum. The dry MDA(PO)₄ adduct containing the KOH catalyst (0.135 g) was weighed into 48 glass inserts. The glass inserts along with the stir paddles were loaded to the corresponding PPR wells and the reactors were sealed. The 24 cells in the top half of the plate were charged manually with 3.99 mL of BO and the 24 cells in the bottom half of the plate were charged with 3.56 mL of BO. The temperature was increased to 115° C. and reaction mixtures were stirred for 2 days after reaching the process temperature to produce the MDA(PO)₄(BO)m intermediates. The pressure in the reactors gradually leveled off, indicating that the reactions were completed forming the MDA(PO)₄(BO)m intermediates. The cells were cooled, vented and purged with nitrogen to remove any residual BO.

Step 3: MDA(PO)₄(BO)m intermediates reaction with EO. To each of the obtained MDA(PO)₄(BO)m intermediates, 1.28 mL of EO were introduced by robot at 50° C. to the top half of the plate and 1.68 mL of EO were added to the bottom half of the plate. Then the temperature was increased to 130° C. and the reactors were stirred for 4 hours to produce the demulsifying block copolymer MDA-(PO)₄(BO)m(EO)n. The pressure curves were consistent with the reaction completion. After cooling and venting the system as described above, small samples of the demulsifying block copolymer MDA-(PO)₄(BO)m(EO)n were taken from each reactor for GPC analyses. Samples with identical starting amounts of reagents having similar GPC and pressure data were combined to give rise to two large samples, EX 15 (86 g) and EX 16 (84 g), which were analyzed by 1H NMR in d6-acetone and GPC. The compositional data and MWs for the large scale demulsifying block copolymer MDA-(PO)₄(BO)m(EO)n inventive samples generated in parallel pressure reactors are listed in Table 4.

### EX 17

Step 1: The initial auto-catalytic reaction with PO was carried out similar to the step 1 procedure in EX 1-10 to give the MDA(PO)₄ adduct.

Step 2: MDA(PO)₄ adduct reactions with PO. The MDA-(PO)₄ adduct with approximately four PO per each MDA as described above served as a starter for the subsequent alkoxylations. The MDA(PO)₄ adduct (10 g) was mixed with calculated amounts of 50 wt. % KOH solutions to make 20 wt. % KOH mixture relative to the MDA(PO)₄ adduct. Then about 100-150 mL of toluene was added and water was removed azeotropically at 110° C. using a Dean-Stark trap. The remaining toluene was evaporated in vacuum. The dry MDA(PO)₄ adduct containing the KOH catalyst (0.135 g) was weighed into 32 glass inserts. The glass inserts along with the stir paddles were loaded to the corresponding PPR wells and the reactors were sealed. The 32 cells on the plate were charged manually with 4.39 mL of PO each. The temperature was increased to 115° C. and reaction mixtures were stirred for 2 days after reaching the process temperature to produce the MDA(PO)q intermediates. The pressure in the reactors gradually leveled off, indicating that the reactions were completed forming the MDA(PO)q intermediates. The cells were cooled, vented and purged with nitrogen to remove any residual PO.

Step 3: MDA(PO)q intermediates reaction with EO. To each of cells with the obtained MDA(PO)q intermediates, 0.84 mL of EO were introduced by robot at 50° C. Then the temperature was increased to 130° C. and the reactors were stirred for 4 hours to produce the demulsifying block copolymer MDA-(PO)q(EO)n. The pressure curves were consistent with the reaction completion. After cooling and venting the system as described above, small samples of the demulsifying block copolymer MDA-(PO)q(EO)n were taken from each reactor for GPC analyses. Samples with identical starting amounts of reagents having similar GPC and pressure data were combined to give rise to a large sample, EX 17 (~98 g), which was analyzed by ¹H NMR in d6-acetone and GPC. The compositional data and MWs for the large scale demulsifying block copolymer MDA-(PO)q(EO)n inventive samples generated in parallel pressure reactors are listed in Table 4.

TABLE 4
Compositions and MWs for EX 15-17

| | wt. % | wt. % | wt. % | wt. % | | | |
|---|---|---|---|---|---|---|---|
| | MDA | PO | EO | BO | Mn | Mw | PD |
| EX 15 | 2.01% | 4.75% | 27.00% | 66.24% | 13622 | 13965 | 1.03 |
| EX 16 | 1.79% | 5.60% | 32.32% | 60.28% | 13445 | 13778 | 1.02 |
| EX 17 | 1.27% | 83.88% | 14.84% | 0 | 13088 | 13757 | 1.05 |

### Comparative Examples (CE) H-J

The performance of a commercially available benchmark additive (CE H) and two incumbent additives (CE I-J) were evaluated. CE H is a polyol block copolymer which contains a different amine initiator and a lower average MW than the present Examples. CE I is a field demulsifier formulation that contains EO/PO block copolymer and alkylphenol formaldehyde resin alkoxylate intermediate. CE J is a knockout drop demulsifier.

Source of Crude Oils used for performance tests are as follows.
Crude Oil A and CE I: Crude Oil emulsion and incumbent CE I from Canada.
Crude Oil B: Emulsion from drilled cutting cleaning process.
Crude Oil C: Crude oil emulsion from Russia.

### Examples (EX) 15-16

Demulsifying block copolymer evaluation for Crude Oil A at 50, 100, and 200 ppm. The efficiency of the demulsifying block copolymers of the present disclosure was evaluated using a standard bottle test method for Crude Oil A at 50, 100, and 200 ppm. The demulsifying block copolymers were heated at 50° C. for 30 min. in a water bath. Then, stock solutions of each demulsifying block copolymer were formulated in a solvent mixture of 3:1 toluene:isopropanol, by mass. The demulsifying block copolymer concentration in the stock solutions was 10 wt. %. Prescription bottles were charged with 100 mL of crude oil emulsion. Subsequently, the additive stock solutions were dosed into the bottles to test the additives at 50, 100, and 200 ppm (based on actives) with respect to the crude oil. The bottles were then placed in pre-heated water bath at 50° C. for 45 min. Upon 45 min., the bottles were removed from the water bath and shaken vigorously for 30 sec and then placed back in the water bath at 50° C. for 30 min. Visual observations were recorded for free water drop at t=0, 10 and 30 min, and the dry oil layer from the top of the sample was recorded for each sample. Upon completion of 30 min, a sample was withdrawn from the 75 mL mark from the top liquid layer of each sample and charged into the standard centrifuge tube to the 50% mark. Toluene was then added to fill the centrifuge tube to the 100% mark. The centrifuge tubes were shaken and then placed in a centrifuge unit and centrifuged at 1200 rpm for 5 min. Upon completion, basic sediment and free water measurements were recorded. The following parameters are reported in Table 5:
Free water drop: amount of water (mL) that separated in the bottle after heating at 50° C. after specified time. A larger number indicates faster drying performance.
Dry oil from top: amount of dry oil (mL) that separated in the bottle after heating at 50° C. after 30 min. A larger number indicates faster drying performance.
% basic sediments (BS): the percentage of basic sediments separated in the graduated tube after centrifugation. A smaller number indicates better performance.
% water (W): the percentage of water separated in the graduated tube after centrifugation. A smaller number indicates better performance.

TABLE 5
Performance results at 50, 100 and 200 ppm of EX 15 and EX 16 screened in Crude
Oil A

| | | | | | | Thief sample | |
|---|---|---|---|---|---|---|---|
| | | | | | | from 75 ml | |
| | PPM | | | | Dry Oil from | mark from top | |
| | (based | | | | top, mL | Centrifuge | |
| | on | Free Water Drop, in mL | | | After | grindout in % | |
| | active) | 0 min | 10 min. | 30 min. | 30 min. | BS | W |
| EX 15 | 50 | 0 | 0 | 0 | 10 | 44 | 0 |
| EX 15 | 100 | 0 | 0 | 0 | 17 | 20 | 0 |
| EX 15 | 200 | 0 | 0 | 0 | 30 | 0.2 | 0 |
| EX 16 | 50 | 0 | 0 | 0 | 8 | 42 | 0 |
| EX 16 | 100 | 0 | 0 | 0 | 24 | 0.2 | 0 |
| EX 16 | 200 | 0 | 0 | 0 | 30 | 0 | 0 |
| CE H | 50 | 0 | 0 | 0 | 10 | 38 | 0 |
| CE H | 100 | 0 | 0 | 0 | 10 | 44 | 0 |
| CE H | 200 | 0 | 0 | 0 | 30 | 0.2 | 0 |
| CE I | 200 | 0 | 0 | 0 | 10 | 42 | 0 |
| CE J | 200 | 0 | 0 | 0 | 10 | 42 | 0 |
| Blank | 0 | 0 | 0 | 0 | 10 | 46 | 0 |

### Performance Results Discussion of EX 15 Screened in Crude Oil A

Dry oil on top and basic sediments and water (BS&W) results were relatively similar at 50 ppm when compared to the CE H sample. However, increasing the dosing concentration of EX 15 offered better properties in emulsion breaking and oil drying as compared to CE H-J. When compared with the CE H, the EX 15 showed superior performance at 100 ppm. Approximately 54.5% less BS&W and 70% improved dry oil volume were observed for EX 15 as compared to the CE H, indicating EX 15 exhibits faster oil drying properties at the higher dosage.

At 200 ppm, EX 15 showed excellent oil drying properties and exhibited better performance than both CE H and CE I and the blank. The data shows the product yields 99.5% less BS&W than both CE H and CE I and the blank, indicating less water was present in the oil for the sample dosed with EX 15.

### Performance Results Discussion of EX 16 Screened in Crude Oil A

Dry oil on top and BS&W results were relatively similar at 50 ppm when compared to CE H. However, increasing the EX 16 dosage offered better properties in emulsion breaking and oil drying. EX 16 showed excellent oil drying properties at 100 ppm and exhibited better performance than CE I and CE J. Significantly less BS&W (99.5%) as compared to the CE I and CE J and blank sample was observed with samples dosed with EX 16, indicating less water was present. When compared with the CE H, EX 16 showed superior performance at 100 ppm and 200 ppm: ~99.5% less BS&W and ~140% improved dry oil volume, indicating EX 16 has faster oil drying properties as compared to CE H.

### Performance Results Discussion of EX 15-16 Screened in Crude Oil B

As described for the evaluation of EX 15 and EX 16 for Crude Oil A, a similar test methodology was used to evaluate EX 15 and EX 16 for Crude Oil B, except the thief was taken after 3 h of heating versus 30 min.

TABLE 6
Performance results at 50, 100 and 200 ppm additive for EX 15 and EX 16 screened in
Crude Oil B

| | | | | | | Thief sample | |
|---|---|---|---|---|---|---|---|
| | | | | | | from 75 ml | |
| | PPM | | | | Dry Oil | mark from top | |
| | (based | | | | from top, | Centrifuge | |
| | on | Free Water Drop, in ml | | | mL | grindout in % | |
| | active) | 0 min | 10 min. | 30 min. | After 3 Hrs | BS | W |
| EX 15 | 50 | 0 | 0 | 0 | 0 | 100 | 0 |
| EX 15 | 100 | 0 | 0 | 0 | 0 | 100 | 0 |
| EX 15 | 200 | 0 | 0 | 22 | 80 | 0 | 0 |
| EX 16 | 50 | 0 | 0 | 0 | 0 | 100 | 0 |
| EX 16 | 100 | 0 | 0 | 0 | 0 | 100 | 0 |
| EX 16 | 200 | 0 | 0 | 16 | 80 | 0 | 0 |
| CE H | 50 | 0 | 0 | 0 | 0 | 100 | 0 |
| CE H | 100 | 0 | 0 | 0 | 0 | 100 | 0 |
| CE H | 200 | 0 | 0 | 0 | 0 | 100 | 0 |
| CE I | 200 | 0 | 0 | 0 | 0 | 100 | 0 |
| CE J | 200 | 0 | 0 | 0 | 0 | 100 | 0 |
| Blank | 0 | 0 | 0 | 0 | 0 | 100 | 0 |

### Performance Results Discussion of EX 15 Screened in Crude Oil B

Dry oil on top and BS&W results were relatively similar at 50 ppm and 100 ppm when compared to CE H-J. However, increasing EX 15 dosage offered better properties in emulsion breaking and oil drying. EX 15 showed excellent oil drying properties at 200 ppm and showed superior performance as compared to CE I and CE J and blank sample. EX 15 shows 99.5% less BS&W as compared to CE I and CE J and blank sample, which indicates more water was removed from the oil.

### Performance Results Discussion of EX 16 Screened in Crude Oil B

Dry oil on top and BS&W results were relatively similar at 50 ppm and 100 ppm when compared to CE H-J. However, increasing EX 16 dosage offered better properties in emulsion breaking and oil drying. EX 16 showed excellent oil drying properties at 100 ppm and showed superior performance as compared to CE I, CE J and blank sample. The data indicates 99.5% less BS&W indicating more water was removed from the oil by EX 16.

### EX 17 Performance Evaluation for Crude Oil C at 300, 600, and 900 ppm

A similar test methodology was used as described for the evaluation of EX 15 and EX 16 screened in Crude Oil A, except EX 17 was dosed at 300, 600 and 900 ppm (based on actives) and the bottles were heated at 45° C. for 45 min. Results are presented in Table 7.

TABLE 7
Performance results at 300, 600, and 900
ppm EX 17 screened in Crude Oil C

| | | | | | Thief sample from | |
|---|---|---|---|---|---|---|
| | PPM | | | | 70 ml mark from top | |
| | (based | | | | Centrifuge | |
| | on | Free Water Drop, in ml | | | grindout in % | |
| | active) | 0 min | 10 min. | 30 min. | BS | W |
| CE I | 300 | 0 | 0 | 0 | 60.0 | 6.0 |
| CE J | 300 | 0 | 0 | 0 | 60.0 | 10.0 |
| Blank | 0 | 0 | 0 | 0 | >70.0 | |
| EX 17 | 300 | 28 | 28 | 28 | 7.4 | 6.0 |
| EX 17 | 600 | 45 | 48 | 48 | 0.8 | 29.2 |
| EX 17 | 900 | 0 | 0 | 0 | 20.0 | 42.2 |

### Performance Results Discussion of EX 17 Screened in Crude Oil

EX 17 showed excellent water dropping properties at 300 ppm and 600 ppm, in comparison to CE I, CE J and blank sample as evidenced by the free water drop at 0, 10, and 30 min. When compared with CE I, CE J and the blank, EX 17 showed superior performance at 300 ppm: 79.8% less BS&W and 28% water drop, indicating faster oil drying properties.

1. A demulsifying block copolymer comprising the reaction product of:
an aniline derived starter containing an alkoxylation catalyst with a first alkylene oxide of butylene oxide to form an intermediate polymer; and
the intermediate polymer with ethylene oxide in the presence of the alkoxylation catalyst to form the demulsifying block copolymer.

2. The demulsifying block copolymer of claim 1, wherein the aniline derived starter has a structure of Formula I: 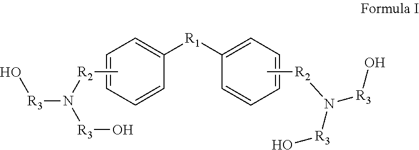
wherein R₁ is a C1 to C3 alkylene or alkylidene; each R₂ is a C0 to C3 alkylene or alkylidene; and R₃ is a C2 or C3 alkylene.

3. The demulsifying block copolymer of claim 1, wherein the aniline derived starter is 4,4′-methylenebis(N,N-di(2-hydroxypropyl)aniline).

4. The demulsifying block copolymer of claim 1, wherein the weight ratio of the butylene oxide to the ethylene oxide in the demulsifying block copolymer is from 1.2-2.7

5. The demulsifying block copolymer of claim 1, wherein the weight average molecular weight of the demulsifying block copolymer is in a range of 10,000 to 18,000 g/mol.

6. The demulsifying block copolymer of claim 1, wherein the aniline derived starter is 0.3 to 2.2 weight percent of the total weight of the demulsifying block copolymer.

7. A method of forming the demulsifying block copolymer of claim 1, comprising:
reacting the aniline derived starter in the presence of the alkoxylation catalyst with the first alkylene oxide of butylene oxide to form the intermediate polymer; and
reacting the intermediate polymer with ethylene oxide in the presence of the alkoxylation catalyst to form the demulsifying block copolymer.

8. A method of demulsifying an emulsion of petroleum and water comprising:
adding a demulsifying block copolymer to the emulsion of petroleum and water, wherein the demulsifying block copolymer comprises the reaction product of:
an aniline derived starter containing an alkoxylation catalyst with a first alkylene of oxide selected from butylene oxide or propylene oxide to form an intermediate polymer; and
the intermediate polymer with ethylene oxide in the presence of the alkoxylation catalyst to form the demulsifying block copolymer; and
allowing the emulsion to separate into a petroleum phase and a water phase.

9. The method of claim 8, wherein adding the demulsifying block copolymer to the emulsion includes adding 2 to 900 parts per million of the demulsifying block copolymer to the emulsion.

10. The method of claim 8, wherein the aniline derived starter has a structure of Formula I: 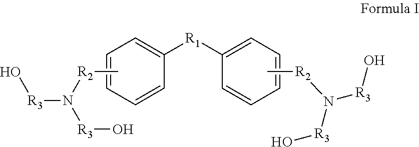
wherein R₁ is a C1 to C3 alkylene or alkylidene; each R₂ is a C0 to C3 alkylene or alkylidene; and R₃ is a C2 or C3 alkylene.

11. The method of claim 8, wherein the aniline derived starter is 4,4′-methylenebis(N,N-di(2-hydroxypropyl)aniline).

12. The method of claim 8, wherein the first alkylene oxide is butylene oxide; or
wherein the first alkylene oxide is butylene oxide and the weight ratio of the butylene oxide to the ethylene oxide in the demulsifying block copolymer is from 1.2-2.7; or
wherein the first alkylene oxide is butylene oxide and the weight average molecular weight of the demulsifying block copolymer is in a range of 10,000 to 18,000 g/mol.

13. The method of claim 8, wherein the first alkylene oxide is propylene oxide; or
wherein the first alkylene oxide is propylene oxide and the weight ratio of the propylene oxide to the ethylene oxide in the demulsifying block copolymer is from 1.0 to 6.0; or
wherein the first alkylene oxide is propylene oxide and the weight average molecular weight of the demulsifying block copolymer is in a range of 7,000 to 15,000 g/mol.

14. The method of claim 8, wherein the aniline derived starter is 0.3 to 2.2 weight percent of the total weight of the demulsifying block copolymer.
